(19) United States
(12) Patent Application Publication
(10) Pub. No.: US 2023/0228852 A1
(43) Pub. Date: Jul. 20, 2023

(54) Optical Sensor with Configurable Pixel Array

(71) Applicant: Artilux, Inc., Menlo Park, CA (US)

(72) Inventors: Tze-Huei Kao, HSINCHU COUNTY (TW); Chien-Lung Chen, HSINCHU COUNTY (TW); Che-Fu Liang, HSINCHU COUNTY (TW); Shu-Lu Chen, HSINCHU COUNTY (TW)

(21) Appl. No.: 17/977,721

(22) Filed: Oct. 31, 2022

Related U.S. Application Data
(60) Provisional application No. 63/301,483, filed on Jan. 20, 2022.

(51) Int. Cl. G01S 7/481; G01S 17/89

(52) U.S. Cl. CPC G01S 7/4816; G01S 17/89

(57) ABSTRACT

An optical sensor includes a plurality of detectors arranged in an array. Each detector of the plurality of detectors includes one or more absorption regions configured to receive an optical signal and generate charge carriers in response to receiving the optical signal; one or more readout regions configured to collect a portion of the charge carriers for output; and one or more control regions coupled to one or more control signals, the one or more control regions configured to control, in response to the one or more control signals, a flow of charge carriers from the one or more absorption regions to the one or more readout regions. The optical sensor includes driver circuitry configured to provide the control signals to enable or disable a subset of the plurality of detectors based on an operating mode of multiple operating modes.

### PRIORITY CLAM

The present application claims a filing benefit of U.S. Provisional Patent Application Ser. No. 63/301,483 having a filing date of Jan. 20, 2022, which is incorporated herein by reference in its entirety.

### FIELD

The present disclosure relates generally to sensor apparatuses. In particular, the present disclosure relates to sensing apparatuses having pixels that can be dynamically controlled based on different application requirements.

### BACKGROUND

Optical sensors are being used in many systems, such as smartphones, wearable electronics, robotics, and autonomous vehicles, etc. for proximity detection, 2D/3D imaging, object recognition, image enhancement, material recognition, color fusion, health monitoring, and other relevant applications. The present disclosure discloses an optical sensor having a configurable/reconfigurable pixel array. The optical sensor can be operable for different wavelength ranges, including visible (e.g., wavelength range 380 nm to 780 nm, or a similar wavelength range as defined by a particular application), near-infrared (NIR, e.g., wavelength range from 780 nm to 1400 nm, or a similar wavelength range as defined by a particular application) and short-wavelength infrared (SWIR, e.g., wavelength range from 1400 nm to 3000 nm, or a similar wavelength range as defined by a particular application) wavelength ranges.

### SUMMARY

Aspects and advantages of embodiments of the present disclosure will be set forth in part in the following description, or may be learned from the description, or may be learned through practice of the embodiments.

One example aspect of the present disclosure is directed to an optical sensor operable in a plurality of operating modes. The optical sensor includes a plurality of detectors arranged in an array. Each detector of the plurality of detectors includes one or more absorption regions, one or more readout regions, and one or more control regions. The one or more absorption regions is configured to receive an optical signal and generate charge carriers in response to receiving the optical signal. The one or more readout regions is configured to collect a portion of the charge carriers for output. The one or more control regions is coupled to one or more control signals, the one or more control regions configured to control, in response to the one or more control signals, a flow of charge carriers from the one or more absorption regions to the one or more readout regions. The optical sensor also includes driver circuitry configured to provide the control signals to enable or disable a subset of the plurality of detectors based on an operating mode of the plurality of operating modes.

In some implementations, the one of more absorption regions include germanium formed on a first silicon substrate.

In some implementations, the plurality of the driver circuitry are formed on a second silicon substrate.

In some implementations, the first silicon substrate is bonded to the second silicon substrate.

In some implementations, the plurality of detectors are arranged in a one-dimensional array or a two-dimensional array.

In some implementations, the plurality of operating modes include any combination of a proximity-sensing mode, a motion-detection mode, a depth-detection mode, a reduced-resolution mode, an enhanced-resolution mode, or a power-saving mode.

In some implementations, under the motion-detection mode, the driver circuitry is configured to enable first detectors of the plurality of detectors located at two or more edges of the array and disable second detectors of the plurality of detectors.

In some implementations, under the proximity-sensing mode, the driver circuitry is configured to enable the second detectors and disable the first detectors.

In some implementations, the optical sensor further includes controller circuitry configured to determine an operating mode of the plurality of optical modes of the optical sensor and to provide an output representing the operating mode to the driver circuitry.

In some implementations, the driver circuitry is configured to provide the control signals to disable the subset of the plurality of detectors by disabling a modulation of the corresponding control regions of the subset of the plurality of detectors to stop a flow of charge carriers through the corresponding control regions.

Another example aspect of the present disclosure is directed to a system including an optical sensor, driver circuitry, and a controller. The optical sensor is operable in a plurality of operating modes. The optical sensor includes a plurality of detectors arranged in an array. Each detector of the plurality of detectors includes one or more absorption regions, one or more readout regions, and one or more control regions. The one or more absorption regions are configured to receive an optical signal and generate charge carriers in response to receiving the optical signal. The one or more readout regions are configured to collect a portion of the charge carriers for output. The one or more control regions are coupled to one or more control signals, the one or more control regions configured to control, in response to the one or more control signals, a flow of charge carriers from the one or more absorption regions to the one or more readout regions. The driver circuitry is configured to provide the control signals to enable or disable a subset of the plurality of detectors based on an operating mode of the plurality of operating modes. The controller is configured to provide a mode signal to the driver circuitry indicating the operating mode of the optical sensor.

In some implementations, the one of more absorption regions include germanium formed on a first silicon substrate.

In some implementations, the plurality of the driver circuitry are formed on a second silicon substrate.

In some implementations, the first silicon substrate is bonded to the second silicon substrate.

In some implementations, the plurality of detectors are arranged in a one-dimensional array or a two-dimensional array.

In some implementations, the plurality of operating modes include any combination of a proximity-sensing mode, a motion-detection mode, a depth-detection mode, a reduced-resolution mode, an enhanced-resolution mode, or a power-saving mode.

In some implementations, the controller is configured to determine an operating mode of the operating modes of the optical sensor based on a user operation of the system.

A still further example aspect of the present disclosure is directed to a method for operating an optical sensor having a plurality of operating modes. The method includes obtaining, by driver circuitry, an input signal representing an operating mode of the plurality of operating modes. The method includes determining, by the driver circuitry, a subset of a plurality of detectors of the optical sensors to be enabled or disabled based on the operating mode. Each detector of the plurality of detectors includes one or more absorption regions, one or more readout regions, and one or more control regions. The one or more absorption regions are configured to receive an optical signal and generate charge carriers in response to receiving the optical signal. The one or more readout regions are configured to collect a portion of the charge carriers for output. The one or more control regions are coupled to one or more control signals, the one or more control regions configured to control, in response to the one or more control signals, a flow of charge carriers from the one or more absorption regions to the one or more readout regions. In response to determining the subset of the plurality of detectors to be enabled or disabled based on the operating mode, the method includes providing, by the driver circuitry to the plurality of detectors, the control signals to the plurality of detectors.

In some implementations, the plurality of operating modes include any combination of a proximity-sensing mode, a motion-detection mode, a depth-detection mode, a reduced-resolution mode, an enhanced-resolution mode, or a power-saving mode.

In some implementations, the plurality of detectors are arranged in an array, and under the motion-detection mode, providing the control signals to the plurality of detectors further includes: enabling first detectors of the plurality of detectors located at two or more edges of the array; and disabling second detectors of the plurality of detectors.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

The foregoing aspects and many of the advantages of this application will become more readily appreciated as the same becomes better understood by reference to the following detailed description, when taken in conjunction with the accompanying drawings:

FIG. 1 illustrates an example of an optical sensor.

FIG. 2 illustrates an example of a two-dimensional array in an optical sensor.

FIGS. 3A-3C illustrate examples of a detector.

FIGS. 4 and 5 illustrate examples of an optical sensor having multiple controllable regions.

FIGS. 6 and 7 illustrate examples of an optical sensor.

FIG. 8 illustrates an example process for operating an optical sensor.

### DETAILED DESCRIPTION

An optical sensor (e.g., an indirect time-of-flight sensor, a direct time-of-flight sensor, an image sensor, a proximity sensor, a bio-signal detector, etc.) can be used in a number of different applications, such as proximity detection, gesture detection, depth-sensing, 2D/3D imaging, object recognition, image enhancement, material recognition, color fusion, health monitoring, and others. In general, a resolution (e.g., VGA, QVGA, etc.) of an optical sensor may be determined based on a number of pixels in the optical sensor, and the resolution requirement for each application may be different. For example, for proximity detection, the optical sensor is mainly used to determine whether something (e.g., a finger, a face, an object, etc.) is within a threshold distance from the optical sensor, and a low resolution (e.g., a low pixel count) may be sufficient. On the other hand, for 3D imaging, a high resolution is required for achieving a high-quality image. To achieve high resolution, the optical sensor can be implemented to include an array (e.g., 1D or 2D) of detector pixels. However, operating a higher number of pixels generally translates to a higher power consumption, which may not be desirable for low-resolution applications such as proximity sensing. In addition, an optical sensor that can operate for different applications (or operating modes) with different power consumptions would generally be desirable. Accordingly, an optical sensor where an operation of pixels can be dynamically controlled (e.g., turning on/off) based on different application requirements at different times may save an overall power consumption of the optical sensor, thereby achieving a technical benefit.

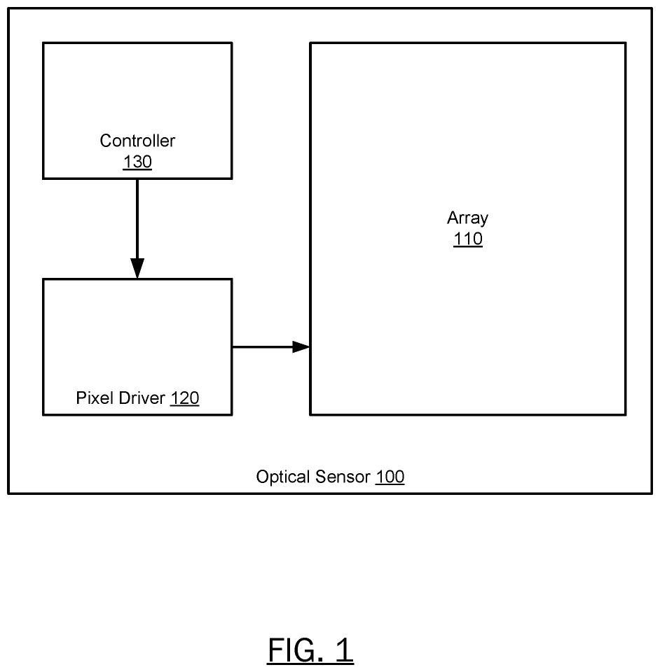

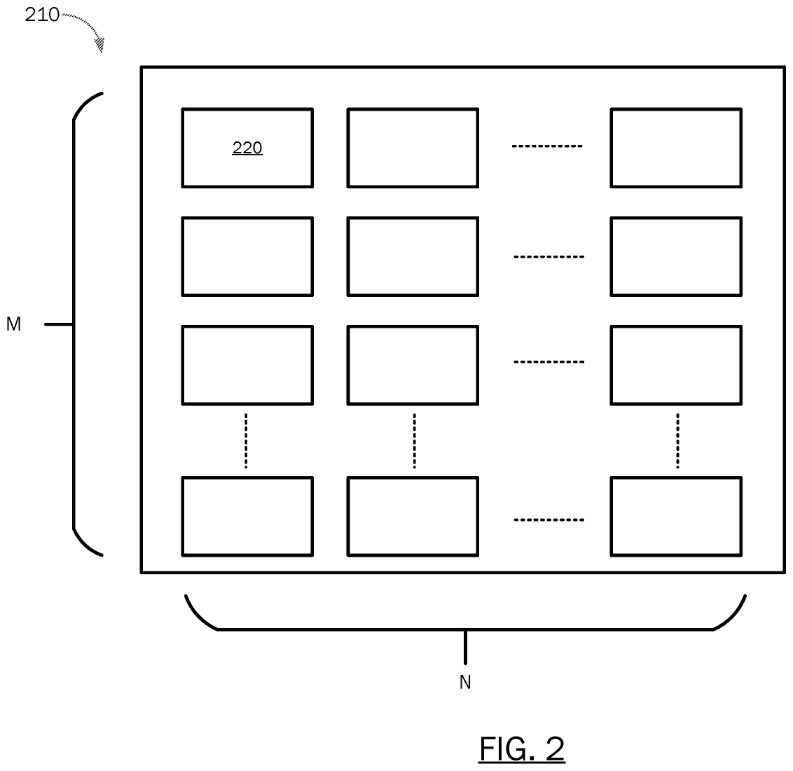

FIG. 1 shows an optical sensor 100 having a plurality of operating modes. The optical sensor 100 includes a plurality of detectors arranged in an array 110. In some implementations, the plurality of detectors can be arranged in a one-dimensional array or a two-dimensional array. FIG. 2 illustrates an example of a two-dimensional array 210 having M rows and N columns of detectors, where M and N are positive integers.

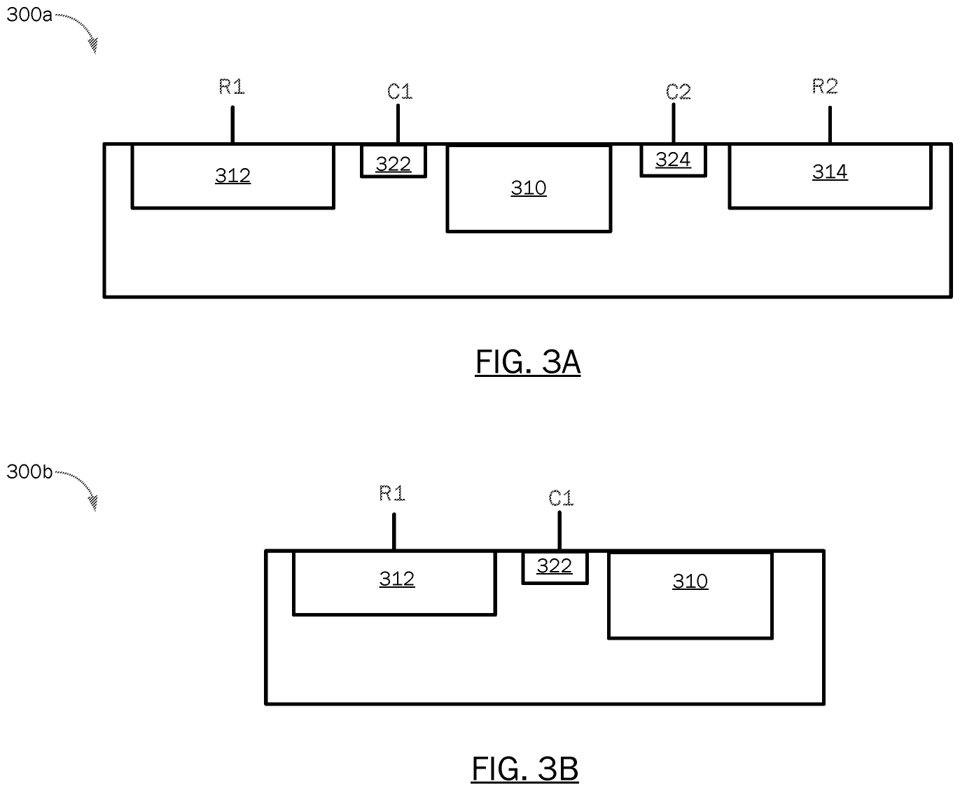

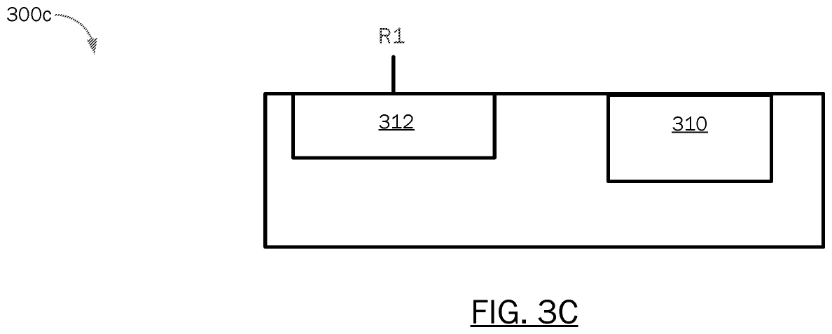

FIGS. 3A-3C illustrate examples of a detector (e.g., detector 220 in FIG. 2). The detector 300a in FIG. 3A is an example two-switch detector for indirect time-of-flight (i-ToF) applications. The detector 300b in FIG. 3B is an example single-switch detector for direct time-of-flight (d-ToF) or image sensing applications. The detector 300c in FIG. 3C is an example single-readout detector for image sensing or proximity sensing applications. In some implementations, each detector of the plurality of detectors includes one or more absorption regions (e.g., absorption region 310 in FIGS. 3A-3C), one or more readout regions (e.g., readout regions 312 and 314 in FIG. 3A, and readout region 312 in FIGS. 3B and 3C), and one or more control regions (e.g., control regions 322 and 324 in FIG. 3A and control region 322 in FIG. 3B). The absorption region 310 is configured to receive an optical signal and generate charge carriers (e.g., electrons and holes) in response to receiving the optical signal. The readout regions 312 and 314 are configured to collect a portion of the charge carriers for output (e.g., through output R1 or R2 to a circuitry for further processing). The one or more control regions are coupled to one or more control signals (e.g., C1 and C2 in FIG. 3A and C1 in FIG. 3B). The one or more control regions 322/324 are configured to control, in response to the one or more control signals C1/C2, a flow of charge carriers (e.g., electrons or holes) from the absorption region 310 to the one or more readout regions 312/314.

Referring back to FIG. 1, the optical sensor 100 further includes pixel driver circuitry 120 configured to provide the control signals to enable or disable a subset of the plurality of detectors based on an operating mode of multiple operating modes. In some implementations, the pixel driver circuitry 120 is configured to enable or disable one or more detectors by providing control signals to enable or disable a modulation of the corresponding control regions of the detectors in order to start or stop a flow of charge carriers through the corresponding control regions. For example, such pixel driver circuitry 120 may be implemented by a combination of logic gates coupled with registers that represent regions of detectors to be turned on or off.

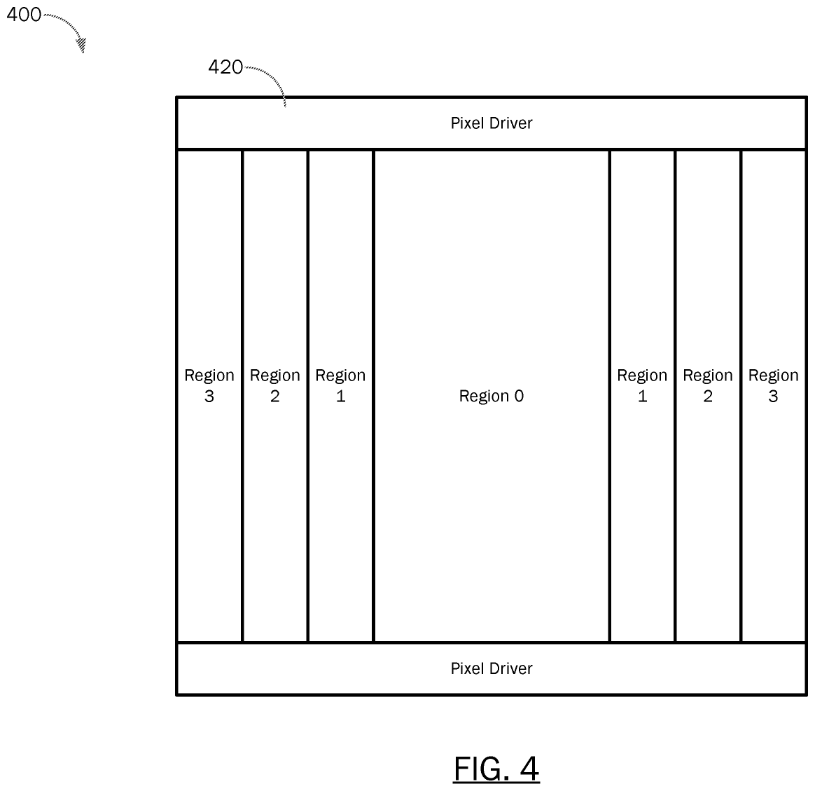

FIG. 4 shows one example of an optical sensor 400, where the detector arrays are divided into multiple regions (e.g., Region 0, Region 1, Region 2, and Region 3). Each of these regions may be controlled individually or collectively by pixel driver circuitry 420 coupled to driver control signals. In some implementations, the regions may have different areas. As an example, Region 0 may be defined using 100-by-256 pixels, and Region 1 may be defined using 50-by-256 pixels. In some other implementations, the regions may have the same areas. In some implementations, a region may be defined statically (e.g., through a pre-defined driver configuration). In some other implementations, a region may be defined dynamically (e.g., through controller 130 during device operation). In some implementations, the regions may be defined along one dimension. In some other implementations, the regions may be defined along two dimensions.

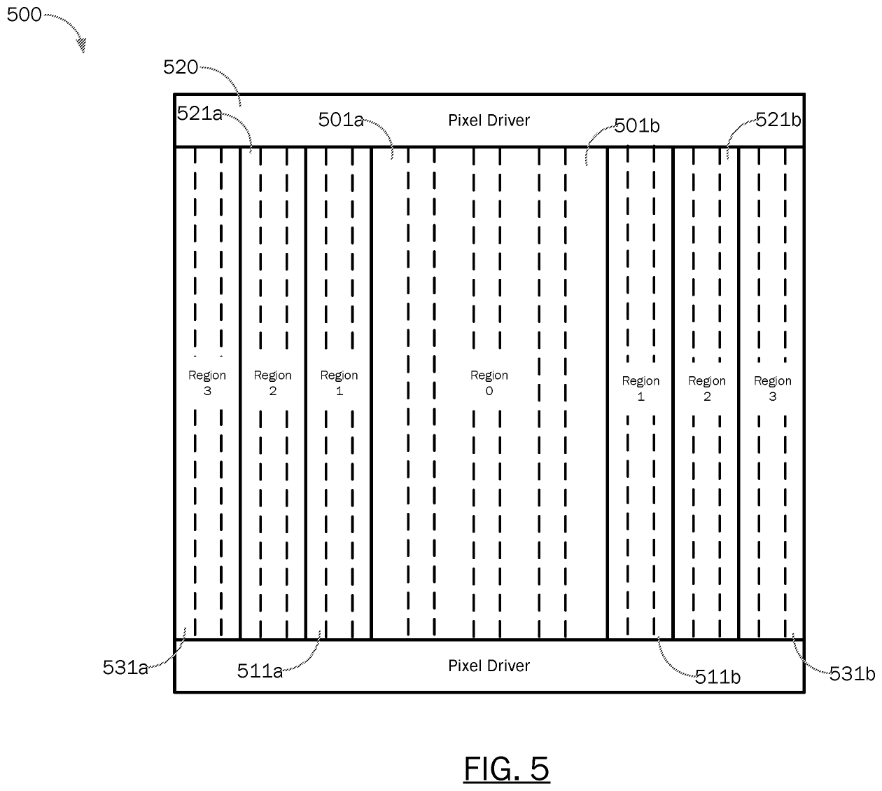

FIG. 5 shows another example of an optical sensor 500, where the multiple regions (e.g., Region 0, Region 1, Region 2, and Region 3) may be further divided into multiple sub-regions (e.g., the sub-regions as defined by dashed lines). The regions and subregions may be controlled by pixel driver circuitry 520 coupled to driver control signals to provide a finer resolution control.

The sensor may operate under multiple operating modes. In some implementations, the operating modes may include any combination of a proximity-sensing mode, a motion-detection mode, a depth-detection mode, a reduced-resolution mode, an enhanced-resolution mode, and/or a power-saving mode. Referring to FIG. 4 as an example, under a motion-detection mode, the driver circuitry 420 may enable first detectors of the plurality of detectors located at the edges of the array (e.g., Region 3) and disable second detectors of the plurality of detectors (e.g., Regions 0-2). Such configuration allows the optical sensor 400 to sense motions such as a hand-gesture (e.g., hand swipe) with a low power consumption.

Referring to FIG. 4 as another example, under a proximity-sensing mode, the driver circuitry 420 may enable a different subset of detectors (e.g., Region 0) and disable others (e.g., Regions 1-3). Such configuration allows the optical sensor 400 to sense if an object (e.g. finger or face) is within a threshold distance from the optical sensor 400 with a low power consumption.

Referring to FIG. 5 as another example, under a reduced-resolution mode, the driver circuitry 520 may enable a different subset of detectors (e.g., 501a/501b/511a/511b/521a/521b/531a/531b of Regions 0-3) and disable others. Such configuration allows the optical sensor 500 to perform applications such as low-resolution depth sensing with a low power consumption

Referring to FIG. 5 as another example, under an enhanced-resolution mode, the driver circuitry 520 may enable all detectors (e.g., all subregions of Regions 0-3). Such configuration allows the optical sensor 500a or 500b to perform applications such as high-resolution 3-D imaging with a higher power consumption.

As another example, under a power-saving mode, the driver circuitry may disable a subset of detectors to meet a power requirement of the optical sensor or a device (e.g., smartphone) that incorporates the optical sensor.

In some implementations, the driver circuitry may dynamically reconfigure the detector array based on different operating modes. For example, the driver circuitry may operate the optical sensor under the proximity-detection mode, and then switch to the motion-detection mode upon detecting an object. In some implementations, the driver circuitry may dynamically reconfigure the detector array based on different operating modes associated with different software applications. For example, the driver circuitry may operate the optical sensor under the high-resolution mode when a user uses a camera software application on a smartphone that incorporates the optical sensor, and then switch to the power-saving mode when the user switches to a content-browsing application that does not require the use of the optical sensor.

In some implementations, the optical sensor (e.g., optical sensor 100) may include additional circuitry within controller 130 (e.g., a microcontroller) configured to determine the operating mode of the optical sensor and to provide an output representing the operating mode of the optical sensor to the driver circuitry. In some other implementations, the controller circuitry may be implemented outside the optical sensor (e.g., on a smartphone).

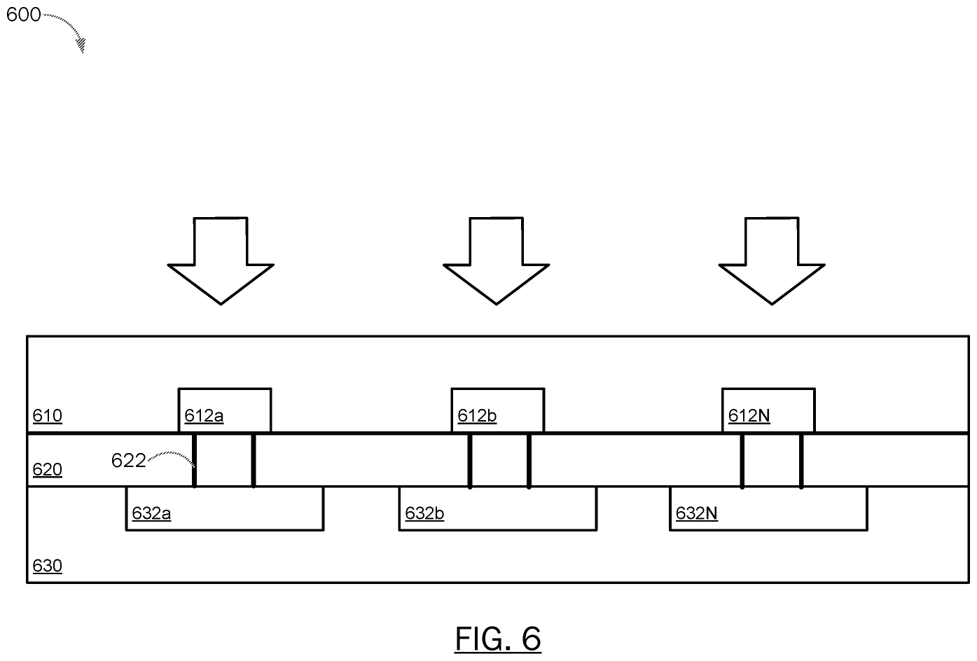

FIG. 6 shows an example of an optical sensor 600 that can be implemented as the optical sensor 100, where the one of more absorption regions 612a-N (N can be any positive integer) are formed using germanium on a first silicon substrate 610. The plurality of the readout circuitry 632a-N and driver circuitry are formed on a second silicon substrate 630, and the first silicon substrate 610 is bonded to the second silicon substrate 630 through a bonding interface 620 (e.g., oxide) with electrical connections 622. In some other implementations, the one of more absorption regions 612a-N may be formed using germanium, silicon, III-V compound materials, or any other suitable materials that absorb light at desirable wavelength(s).

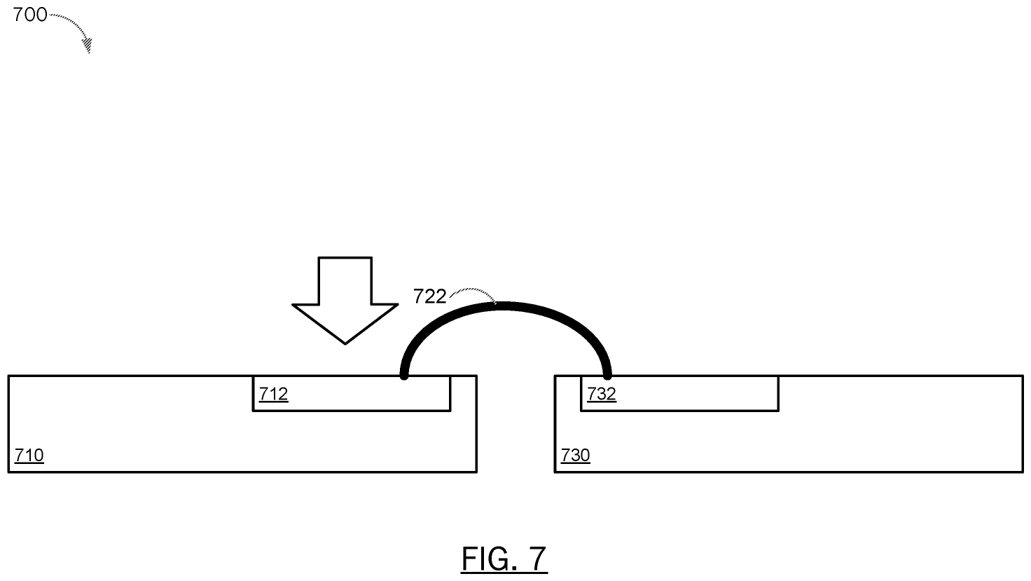

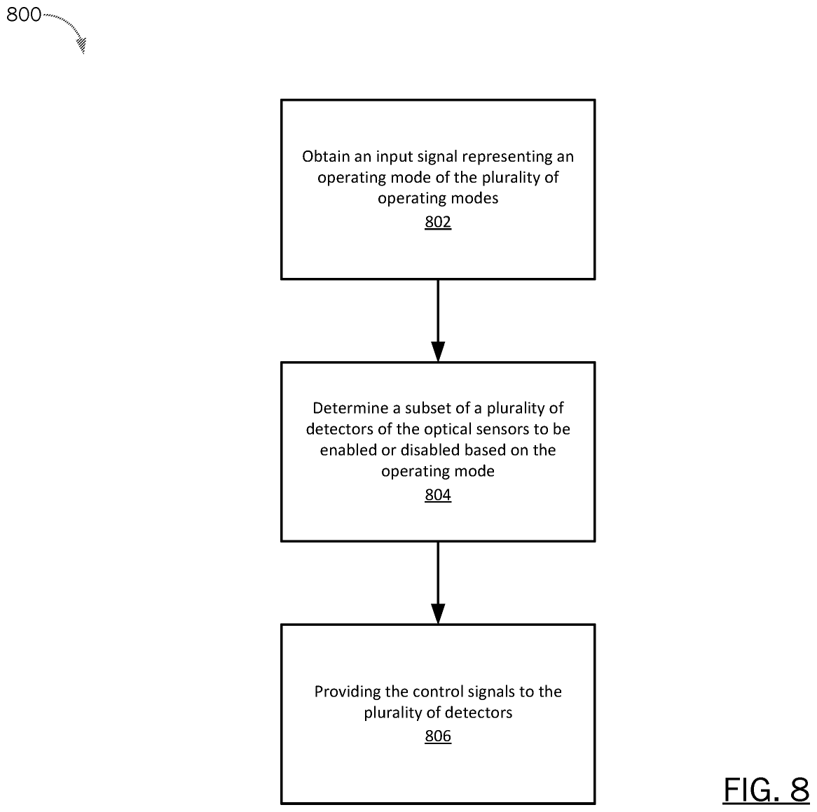

FIG. 7 shows another example of an optical sensor 700 that can be implemented as the optical sensor 100, where the one of more absorption regions 712 (e.g., germanium, silicon, III-V compound materials, or any other suitable materials that absorbs light at desirable wavelength(s)) are formed on a first silicon substrate 710. The plurality of the readout circuitry 732 and driver circuitry are formed on a second silicon substrate 730, and the first silicon substrate 710 are wire-bonded to the second silicon substrate 730 through electrical connections 722.

FIG. 8 illustrates an example process 800 for operating an optical sensor having a plurality of operating modes. The flow can be implemented using a system (e.g., a smartphone, wearables, etc.) incorporating an optical sensor such as the optical sensor 100. The process includes obtaining, by driver circuitry, an input signal representing an operating mode of the plurality of operating modes (802); determining, by the driver circuitry, a subset of a plurality of detectors of the optical sensors to be enabled or disabled based on the operating mode (804); and in response to determining the subset of the plurality of detectors to be enabled or disabled based on the operating mode, providing, by the driver circuitry to the plurality of detectors, the control signals to the plurality of detectors (806).

While the disclosure has been described by way of example and in terms of a preferred embodiment, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical sensor operable in a plurality of operating modes, the optical sensor comprising:
a plurality of detectors arranged in an array,
wherein each detector of the plurality of detectors comprises:
one or more absorption regions configured to receive an optical signal and generate charge carriers in response to receiving the optical signal;
one or more readout regions configured to collect a portion of the charge carriers for output; and
one or more control regions coupled to one or more control signals, the one or more control regions configured to control, in response to the one or more control signals, a flow of charge carriers from the one or more absorption regions to the one or more readout regions; and
driver circuitry configured to provide the control signals to enable or disable a subset of the plurality of detectors based on an operating mode of the plurality of operating modes.

2. The optical sensor of claim 1, wherein the one of more absorption regions comprise germanium formed on a first silicon substrate.

3. The optical sensor of claim 2, wherein the plurality of the driver circuitry are formed on a second silicon substrate.

4. The optical sensor of claim 3, wherein the first silicon substrate is bonded to the second silicon substrate.

5. The optical sensor of claim 1, wherein the plurality of detectors are arranged in a one-dimensional array or a two-dimensional array.

6. The optical sensor of claim 1, wherein the plurality of operating modes comprise any combination of a proximity-sensing mode, a motion-detection mode, a depth-detection mode, a reduced-resolution mode, an enhanced-resolution mode, or a power-saving mode.

7. The optical sensor of claim 6, wherein under the motion-detection mode, the driver circuitry is configured to enable first detectors of the plurality of detectors located at two or more edges of the array and disable second detectors of the plurality of detectors.

8. The optical sensor of claim 7, wherein under the proximity-sensing mode, the driver circuitry is configured to enable the second detectors and disable the first detectors.

9. The optical sensor of claim 1, comprising:
controller circuitry configured to determine an operating mode of the plurality of optical modes of the optical sensor and to provide an output representing the operating mode to the driver circuitry.

10. The optical sensor of claim 1, wherein the driver circuitry is configured to provide the control signals to disable the subset of the plurality of detectors by disabling a modulation of the corresponding control regions of the subset of the plurality of detectors to stop a flow of charge carriers through the corresponding control regions.

11. A system comprising:
an optical sensor operable in a plurality of operating modes, the optical sensor comprising:
a plurality of detectors arranged in an array,
wherein each detector of the plurality of detectors comprises:
one or more absorption regions configured to receive an optical signal and generate charge carriers in response to receiving the optical signal;
one or more readout regions configured to collect a portion of the charge carriers for output; and
one or more control regions coupled to one or more control signals, the one or more control regions configured to control, in response to the one or more control signals, a flow of charge carriers from the one or more absorption regions to the one or more readout regions;
driver circuitry configured to provide the control signals to enable or disable a subset of the plurality of detectors based on an operating mode of the plurality of operating modes; and
a controller configured to provide a mode signal to the driver circuitry indicating the operating mode of the optical sensor.

12. The system of claim 11, wherein the one of more absorption regions comprise germanium formed on a first silicon substrate.

13. The system of claim 12, wherein the plurality of the driver circuitry are formed on a second silicon substrate.

14. The system of claim 13, wherein the first silicon substrate is bonded to the second silicon substrate.

15. The system of claim 11, wherein the plurality of detectors are arranged in a one-dimensional array or a two-dimensional array.

16. The system of claim 11, wherein the plurality of operating modes comprise any combination of a proximity-sensing mode, a motion-detection mode, a depth-detection mode, a reduced-resolution mode, an enhanced-resolution mode, or a power-saving mode.

17. The system of claim 11, wherein the controller is configured to determine an operating mode of the operating modes of the optical sensor based on a user operation of the system.

18. A method for operating an optical sensor having a plurality of operating modes, the method comprising:
obtaining, by driver circuitry, an input signal representing an operating mode of the plurality of operating modes;
determining, by the driver circuitry, a subset of a plurality of detectors of the optical sensors to be enabled or disabled based on the operating mode,
wherein each detector of the plurality of detectors comprises:
one or more absorption regions configured to receive an optical signal and generate charge carriers in response to receiving the optical signal;
one or more readout regions configured to collect a portion of the charge carriers for output; and
one or more control regions coupled to one or more control signals, the one or more control regions configured to control, in response to the one or more control signals, a flow of charge carriers from the one or more absorption regions to the one or more readout regions; and
in response to determining the subset of the plurality of detectors to be enabled or disabled based on the operating mode, providing, by the driver circuitry to the plurality of detectors, the control signals to the plurality of detectors.

19. The method of claim 18, wherein the plurality of operating modes comprise any combination of a proximity-sensing mode, a motion-detection mode, a depth-detection mode, a reduced-resolution mode, an enhanced-resolution mode, or a power-saving mode.

20. The method of claim 19, wherein:
the plurality of detectors are arranged in an array; and
under the motion-detection mode, providing the control signals to the plurality of detectors further comprises enabling first detectors of the plurality of detectors located at two or more edges of the array; and disabling second detectors of the plurality of detectors.
